(19) United States
(12) Patent Application Publication
(10) Pub. No.: US 2017/0013853 A1
(43) Pub. Date: Jan. 19, 2017

(54) SMOOTH COTTAGE CHEESE AND COTTAGE CHEESE PRODUCT, PROCESS AND METHOD

(71) Applicant: GAY LEA FOODS CO-OPERATIVE LTD., Mississauga (CA)

(72) Inventor: Ganjuan LUO, Guelph (CA)

(21) Appl. No.: 14/802,889

(22) Filed: Jul. 17, 2015

(51) Int. Cl. A23C 19/076; A23C 19/032; A23C 19/045; A23C 19/05

(52) U.S. Cl. CPC A23C 19/0765; A23C 19/05; A23C 19/0323; A23C 19/076; A23C 19/032; A23C 19/0455; A23Y 2220/00; A23Y 2240/41; A23Y 2240/21; A23Y 2260/00; A23Y 2260/45; A23Y 2280/00; A23Y 2320/00; A23Y 2240/75

(57) ABSTRACT

The present disclosure relates generally to smooth cheese products and method of producing smooth cheese products.

### FIELD

The present disclosure relates generally to smooth cottage cheese products and method of producing smooth cottage cheese products.

### BACKGROUND

Cottage cheese is a fresh cheese product, which typically is mixture of a fresh dressing with curd. It has bland to slightly acidic in flavour, with a uniform coating of dressing surrounding tender white curd pieces. Different styles of cottage cheese are made from milk with different fat levels and in small-curd or large-curd preparations. Cottage cheese is a low calorie dairy product and a great source of protein, minerals and vitamins, desirable for use as snack, in salads and as an ingredient in meals.

### SUMMARY

In one aspect of the present disclosure there is provided a method of producing a smooth cheese product, comprising, preparing a cheese curd from a milk source, said cheese curd having a firmness of between about 80 pounds of force (lbs of force) to about 250 lbs force; mixing the cheese curd with a dressing to form a mixture; and subjecting the mixture to a smoothing step to produce the smooth cheese product, wherein the smooth cheese product is flowable at temperatures of about 4° C. to about 20° C., and has a viscosity is in the range of about 5000 to about 80000 cP (where 1.0020 mPa·s=1.0020 cP) following the smoothing step.

In one example the step of preparing a cheese curd comprises, coagulating a milk source with a coagulant to form a coagulated curd and whey; cutting the coagulated curd in the whey; healing the cut coagulated curd; heating the healed cut coagulate curd and whey; and separating the cut coagulated curd from the whey.

In one example said smoothing step comprises, applying a shearing force or milling force to the mixture.

In one example said shearing force or milling force is produced with a device to generate a particle size of the curd less than about 1000 μm.

In one example said device comprises one or more rotor/stator heads, which rotate between about 1000 rpm to about 6000 rpm.

In one example said device is a Boston Shear Mill, or a Quadra Z emulsifier.

In one example said device is a STEPHAN MICROCUT®.

In one example said milk source comprises milk from a mammal.

In one example said mammal is a cow, buffalo, goat, sheep, horse, donkey, water buffalo, yak, reindeer, or camel.

In one example said coagulant comprises an enzyme.

In one example said enzyme comprises rennet, rennin, chymosin, CHY-MAX® M, CHY-MAX® EXTRA, CHY-MAR®, HANNILASE®, THERMOLASE®, NATUREN®, or FAR-M®.

In one example said coagulant comprises an acidifier.

In one example said acidifier comprises CO₂, organic acids, inorganic acids, lactic acid, citric acid, hydrochloric acid, phosphoric acid, oxalic acid, tartaric acid, fumaric acid, succinic acid, malic acid, gluconic acid, adipic acid, and phytic acid, or glucono-delta-lactone.

In one example said coagulant comprises a lactic acid producing bacterium.

In one example said lactic acid producing bacterium comprises a bacterium from the order Lactobacillales or Actinomycetales.

In one example said lactic acid producing bacterium comprises, Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp.

In one example said lactic acid producing bacterium comprises, Streptococcus lactis, Streptococcus cremoris, Lactococcus lactis, and/or Lactococcus cremoris.

In one example said lactic acid producing bacterium comprises, Streptococcus thermophilus

In one example said cutting is manual or automated.

In one example said healing comprises incubating said cut coagulated curd for a healing time, wherein said healing time is about 20 to about 40 min.

In one example said heating step comprises heating said cut curd coagulum and whey at a cooking temperature and a cooking time to achieve the firmness of the cut curd coagulum of about 80 pounds of force (lbs of force) to about 250 lbs force (as measured for example, by a texture analyzer.

In one example said separating step comprises liquid removal with a curd drainer.

In one example further comprising addition of at least one additional ingredient.

In one example said at least one additional ingredient is a sweetener, a flavour, an aroma, a colour, a spice, a fruit, a flavor preparation, or a salt.

In one aspect of the present disclosure there is provided a smooth cheese product made according to a method described herein, wherein said smooth cheese product is flowable at a temperature of about 4° C. to about 20° C., has a viscosity of about 5000 cP to about 80000 cP, and has a particle size of less than about 1000 μm

In one example, said smooth cheese product comprises about 10% to about 20% protein, about 1-10% fat, and about 15-30% solids.

In one aspect of the present disclosure there is provided a smooth cheese product comprising about 10% to about 20% protein, about 1 to 10% fat, and about 15-30% solids, wherein said smooth cheese product is flowable at a temperature of about 4° C. to about 20° C., has a viscosity of about 5000 cP to about 80000 cP, and has a particle size of curd of from about 10 μm to 1000 μm.

In one example further comprising an additional ingredient.

In one example said additional ingredient is one or more of a salt, a sweetener, acetic acid, vinegar, food grade acid, aromas, spice, flavor seasoning, cocoa, mustard, coloring agent, tomato, sweet pepper, vitamin, antioxidant, preservative, flavour preparation, food colorants and/or dyes.

In one example said flavor is vanilla, hazelnut, Irish creme, mocha, coco, almond, liqueurs, chocolate, berry, or fruit.

In one example said antioxidant is ethoxyquin, vitamin E, vitamin C, BHA, BHT, TBHQ, or ascorbyl palmitate.

In one example said preservative is sorbate, or benzoate.

### BRIEF DESCRIPTION OF THE DRAWINGS

Embodiments of the present disclosure will now be described, by way of example only, with reference to the attached Figures.

FIG. 1 is a flow chart depicting the production of a cheese curd;

FIG. 2 is a flow chart depicting the production of a dressing;

FIG. 3 is a flow chart depicting the fermentation of the dressing;

FIG. 4 is a flow chart depicting the production of a smooth cheese product;

FIG. 5 is a flow chart depicting the inclusion of an additional ingredient in the smooth cheese product; and

FIG. 6 is a flow chart depicting the production of a whipped smooth cheese product.

### DETAILED DESCRIPTION

Generally, the present disclosure provides smooth cheese products and methods of producing smooth cheese products.

In conventional manufacturing processes for cottage cheese, for example, cheese curds are suspended in, or blended with, a dressing, to form cottage cheese.

One reason for non-cottage cheese eaters to avoid cottage cheese is the lumpy curd texture.

It would be desirable to manufacture a cheese product with the nutritional benefits of cottage cheese, but with a smooth texture, for example, to eat alone, together with additives, as a healthy snack, and/or in cooking.

It has been surprisingly determined herein that specific formulations and/or properties of the cheese curd, the dressing, and processing parameters when combining the curd and dressing, result in a smooth product (also referred to as a smooth cheese product), of desired texture and viscosity. Further, the viscosity of the smooth cheese product is substantially maintained after processing, for example, for an extended period of time subsequent to subsequent to packaging.

In one example, the smooth cheese product is fresh cheese. Fresh cheese includes, but is not limited to cheeses suitable for human consumption in a fresh state or after a short period of ripening. Fresh cheese, suitable for use in the process and method herein comprises, about 5% (wt/wt) to about 15% (wt/wt) protein, about 1% (wt/wt) to about 10% (wt/wt) fat, and about 15% (wt/wt) to about 30% (wt/wt) solids.

Fresh cheeses include, for example, cheeses made of cream, whey cheeses and various curd cheeses. Examples of fresh cheeses include, but are not limited to, cottage, fromage frais, Bauernkse, Quark, Ricotta, and turo.

In a specific example, the fresh cheese is cottage cheese.

In case of fresh cheese, for example cottage cheese, curds are obtained by coagulation of a milk source. Coagulation is obtained by enzyme treatment of the milk source or by acid treatment of the milk source, or both enzyme treatment of the milk source and by acid treatment of the milk source. In the case in which coagulation is obtained by enzyme treatment of the milk source and by acid treatment of the milk source, the enzyme treatment and acid treatment may be sequential treatment or concurrent treatment.

A milk source includes milk and/or a milk based composition.

Milk is obtained from any animal the milk of which is suitable for human consumption. As used herein, the term “milk” includes any normal secretion obtained from the mammary glands of mammals, including, but not limited to, cow, buffalo, goat, sheep, horse, donkey, water buffalo, yak, reindeer, camel, or other animal producing milk suitable for human consumption. Milk also refers to mixture of milk from different species of mammals. In a specific example, the milk is cow milk.

As used herein, the term “milk based composition” refers to milk(s) or milk products containing milk derived proteins, including but not limited to raw or processed.

Milk includes whole milk, skim milk, reduced fat milk, fat enhanced milk, buttermilk, condensed milk, lactose, mother liquor from crystallization of lactose, cream, whey permeate, whey, milk ultrafiltration retentates, milk concentrates, milk powders, and milk powders reconstituted to form a solution, as well as milk products derived from these, and combinations thereof.

Milk may processed by concentrating, filtering, sterilizing, pasteurizing, and homogenizing.

Milk may be prepared, totally or in part, from dried milk fractions, such as, for example, whole milk powder, skim milk powder, casein, caseinate, milk protein concentrates and isolates, total milk protein or buttermilk powder, or any combination thereof.

In some examples, the milk source may be substituted with non-milk protein, for example from soya or pea protein concentrates or isolates. In specific examples, the fraction of non-milk protein is in the range of 0% to about 50% (wt/wt).

The term homogenizing or homogenization, as used herein, refers to mixing so as to obtain a soluble suspension or emulsion. If homogenization is performed prior to fermentation, it may be performed so as to break up the milk fat into smaller sizes so that it no longer separates from the milk. The homogenization may be also performed to obtain a homogeneous suspension of proteins, when protein is from different sources. This may be accomplished by forcing the milk at high pressure through small orifices or using microfluidics based homogenizers, or colloid mills.

The term pasteurizing or pasteurization, as used herein, refers to treatment to reduce or eliminate the presence of, for example, microorganisms. Pasteurization is generally carried out by maintaining a specified temperature and pressure for a specified period of time. The temperature and duration are selected in order to kill or inactivate certain bacteria, such as harmful bacteria, and/or to inactivate enzymes in the milk. A rapid cooling step may follow.

Producing a Cheese Curd of a Specific Firmness

The method of preparing a smooth cheese product as described herein comprises producing a cheese curd of a specific firmness.

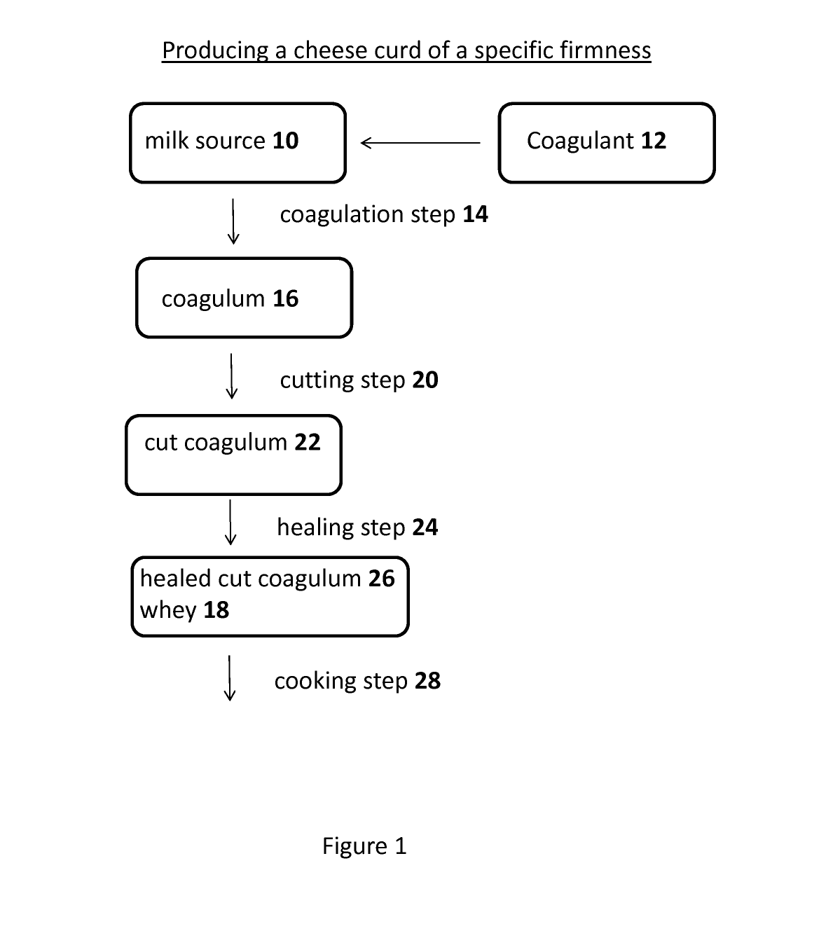

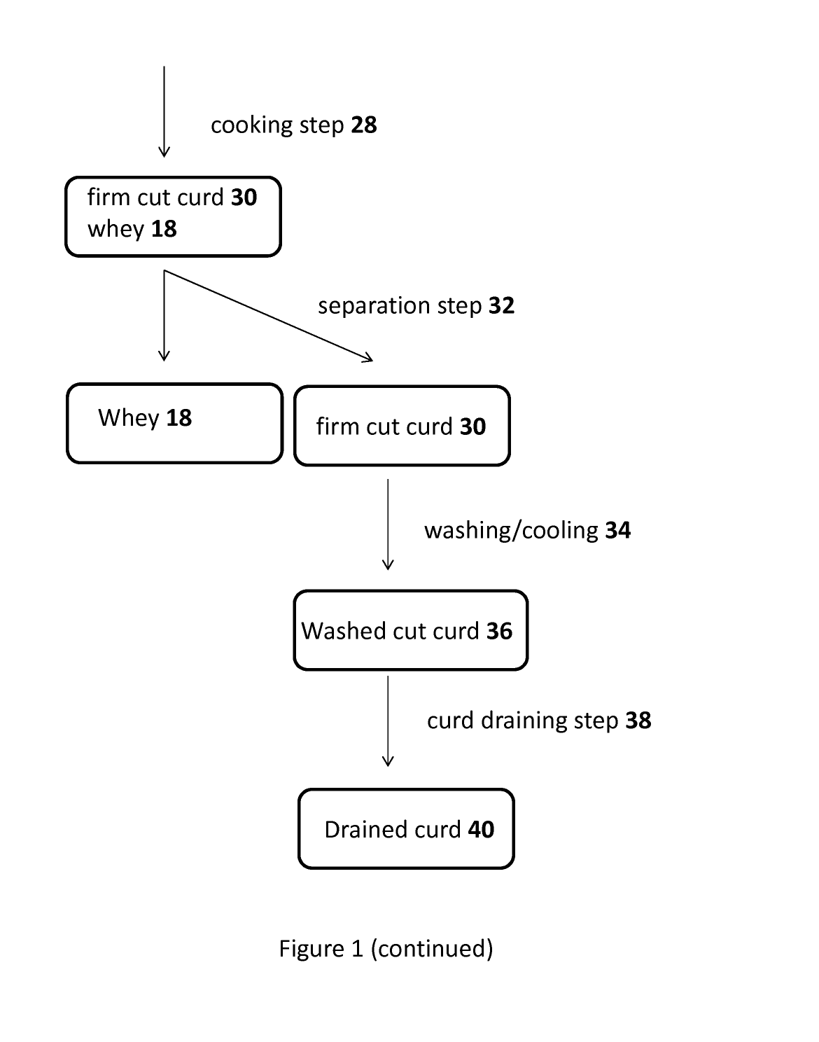

One example of cheese curd preparation of a specific firmness is shown in FIG. 1. In FIG. 1, a milk source 10 is combined with a coagulant 12, in a coagulation step 14 to produce a coagulum 16. Milk source 10 may be a milk or milk based composition. As described hereinafter, “coagulant” refers to a suitable milk source clotting agent. In some examples, coagulation may be effected by enzyme treatment of the milk source or by acid treatment of the milk source, or both enzyme treatment and acid treatment of the milk source.

In one example, the coagulant is an enzyme derived from microbial, vegetable or animal tissue sources. In other examples, the milk clotting enzyme is a recombinant protein obtained by heterologous or homologous production of the recombinant protein in a cell(s) of animal or microbial origin.

In some examples, the enzyme is rennet, rennin, a protease, chymosin, the like, or mixtures thereof. In some example, the enzyme is bovine chymosin purified from abomasum tissue or made by fermentation. In some examples, the enzyme is CHY-MAX® M, CHY-MAX® EXTRA, CHY-MAR®, HANNILASE®, THERMOLASE®, NATUREN®, FAR-M® (from Hansen A/S).

In some examples, coagulation is induced by the action of rennet at pH close to the isoelectric point of casein.

In use, chymosin may be mixed into the milk mixture. The milk and chymosin mixture is then allowed to incubate until a pH of the reaction mixture (containing the milk source and coagulating curd) about 4.6-5.5. In some examples, the milk and chymosin mixture is then allowed to incubate up to about five hours.

Alternately or additionally, coagulation is caused by acidification of the milk mixture. Acidification causes coagulation of milk and the formation of cheese curds. Acidification may also aid in inhibition of the growth of many pathogenic and spoilage bacteria which may contaminate the milk.

In some examples, acidification of the milk source 10 is achieved by adding a coagulant 12, which comprises adding one or more acidifiers to the milk source.

Acidifiers include, but are not limited to, organic acids and inorganic acids, including lactic acid, citric acid, hydrochloric acid, phosphoric acid, oxalic acid, tartaric acid, fumaric acid, succinic acid, malic acid, gluconic acid, adipic acid, and phytic acid, glucono-delta-lactone, CO₂, and the like, or mixtures thereof. In some examples, acids are added in the range of 0.01% (wt/wt) to about 3% (wt/wt).

In use, the acidifier is added to the heat treated and optionally cooled milk base. The amount of the acidifier may range between 0.01% (wt/wt) and 3% (wt/wt), calculated from the total weight of mixture.

In some example, acidification of the milk source 10 is achieved by treatment with acid producing bacteria.

Examples of acid producing bacteria include, but are not limited to lactic acid-producing bacteria, including gram positive, microaerophilic, or anaerobic bacterium, which ferment sugars with the production of acids including lactic acid as the predominantly produced acid, acetic acid and propionic acid, which acidifies the milk.

In some examples, lactic acid bacteria strains are a member of the order Lactobacillales or Actinomycetales. In Specific examples, the lactic acid bacteria include, but are not limited to Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp.

Specific example of lactic acid-producing bacterial, include, Streptococcus lactis, Streptococcus cremoris, Lactococcus lactis, and/or Lactococcus cremoris.

In another example, the lactic acid producing bacterium is Streptococcus thermophilus a thermophilic lactic bacterium. S. thermophilus may result in a shorter fermentation time, however, may also produce urease, an enzyme catalyzing hydrolysis of urea into carbon dioxide and ammonia. In some examples the S. thermophiles is a urease negative (Ur−) S. thermophilus strain.

In some examples, anaerobic bacteria, Bifidobacteria, for example, Bifidobacterium spp., is used alone or in combination with lactic acid bacteria.

It will be appreciated that optimal formation temperatures will vary with the microbial strain used.

Lactic acid producing bacteria, including Lactococcus lactis, may be supplied, and used as, as frozen or freeze-dried cultures. This is also referred to as “Direct Vat Set” (DVS) cultures, intended for direct inoculation into a fermentation vessel or vat for the production of cheese curds. Bulk starters may also be used for propagation.

Such DVS cultures are also referred to as “starter cultures” or “starters”. A suitable package containing DVS cultures may be a bag, a sealed plastic bag, a bottle, a container, for example, containing from 10 g to 5000 g of DVS culture.

In use, the milk may be inoculated with about 10⁴ to 10¹³ cfu/ml (i.e. cell- or colony-forming units per milliliter), preferably about 10⁶ to 10¹² cfu/ml, or more preferably about 10⁸ to 10¹² cfu/ml, of the bacteria.

Another example of microbial starter cultures includes fungal cultures, including yeast cultures and cultures of filamentous fungi. Examples of fungi include Penicillium roqueforti, Penicillium candidum, Geotrichum candidum, Torula kefir, Saccharomyces kefir and Saccharomyces cerevisiae. In some example, bacterial culture and fungal cultures are mixed.

As a result of fermentation, pH of the milk source is lowered.

In some example, fermentation of the milk source with the bacteria, fungi, or mixtures thereof, is under conditions of a fermentation time and a fermentation temperature so as lower the pH of the milk source from the starting pH, in some example about pH 6.6 (i.e. the pH of milk), to a pH of between about 3.5 and about 5.5. In some examples, the pH is between about 4.5 and about 5.0. In some examples the pH is between about 4.7 and about 4.9. In specific example, the pH is about 3.5, 3.55, 3.6, 3.65, 3.7, 3.75, 3.8, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, 5, 5.05, 5.1, 5.15, 5.2, 5.25, 5.3, 5.35, 5.4, 5.45, or 5.5.

In some examples, the fermentation time is in the range of about 3 hour to about 10 hours. In some examples, the fermentation time is about 3, 4, 5, 6, 7, 8, 9, or 10 hours. In some examples, the fermentation is more than about 10 hours.

The reaction of the milk source 10 and coagulant 12 results in the production of a coagulum 16.

Whey 18, as used herein, refers to the liquid composition which is left when casein has been removed from milk.

Following the coagulation step 14, the resultant coagulum 16 is cut into portions of desired dimension(s) in a cutting step 20. Preferably, the resultant cut coagulum 22 are of generally of monodisperse dimension. Cutting may be manual or automated. The coagulum is preferably cut into small portions. In some examples, the coagulum 16 is cut with a knife from about 2/8 inch to about 6/8 inch. In a specific example, in the case of “small curd style”, the coagulum 16 is cut with ¼ inch knives, have curd particles approximately ¼ inch or less in size. In a specific example, in the case of “large curd style”, the coagulum 16 is cut with knives over ⅜ inch, and have curd particles approximately ⅜ inch in size.

In manual cutting, cutting harps made by stretching stainless steel wire over a stainless steel frame may be used. Cut curd size will be determined by the dimensions of the steel wires within the frame. The cutting time is selected to avoid oversetting of the curd. In some examples, the cutting knives are pulled quickly through the curd so has to cut the curd cleanly.

In automated cutting, cut curd size is determined by the design of the vat and agitators, the speed of cutting and the duration of cutting. Preferably, the knives are sharp and cut the curd cleanly. In some examples, the coagulum 16 is cut using ⅜ inch knives with a carriage maximum travel speed of 50%.

In another example, the curd is prepared in a continuous coagulator, (not shown) with extrusion of the curd at the end of the coagulation process. For example, the ALPMA continuous coagulator could be used.

Following the cutting step 20, the cut coagulum 22 is permitted to heal in a healing step 24, to produce a coagulum 26 and whey 18. Healing refers to process by which the exterior surfaces of cut coagulum 22 are allowed to close (i.e., heal) following the cutting step 20 so as to minimize or reduce loss of fat and protein from the cut coagulum 22 into the whey 18. For example, during the healing step 24 the cut coagulum 22 is agitated gently during the healing step. In other examples the cut coagulum 22 is incubated without agitation during the healing step 20. The conditions of the healing step 24 are selected so as to avoid or minimize the formation of fines. In one example, the cut coagulum 22 is incubated for a healing time, without agitation, for about 20 to about 40 minutes. In some examples, the healing time is about 20, 21, 22, 23, 24, 25, 26, 27, 28, 29, 30, 31, 32, 33, 34, 35, 36, 37, 38, 39, or 40 min.

Following the healing step 24, the healed cut coagulum 26 and whey 18 are subjected to a cooking step 28 to generate a firm cut curd 30 and whey 18. In this cooking step 28, the healed cut curd coagulum 26 and whey 18 are heated at a cooking temperature and a cooking time to achieve a firmness of the cut curd coagulum 30 of about 80 pounds of force (lb of force) to about 250 lb force. In some examples, the firmness is from about 80 lb force to about 150 lb force. In specific example, the firmness is about 80, 85 90, 95, 100, 105, 110, 115, 120, 125, 130, 135, 140, 145, 150, 160, 170, 180, 190, 195, 200, 205, 210, 215, 220, 225, 230, 235, 240, 245, or 250 lb of force. Firmness may be measured in a variety of ways, for example, measured using puncture or peak force test with a with Tenderometer TM-2 Food Texture System, measured using rheometers, texturometers, or by sensory evaluation. Usually when measured by texture analyzer the test is carried out as a peak force measurement, or as texture profile analysis as well known in the literature.

In some examples, the healed cut coagulum 26 and whey 18 are heated to a cooking temperature between about 45° C. and about 70° C. In some examples, the cooking between about 50° C. and about 70° C.

The cooking step 28 is held at the cooking temperature for a cooking time. In some examples, the cooking time is about 0.5 h to about 2 h. In some examples, the cooking time is about forty five minutes to about 1.5 h. In some example, the cooking time is about 0.5, 0.6, 0.7, 0.8, 0.9, 1, 1.1, 1.2, 1.3, 1.4, 1.5, 1.6, 1.7, 1.8, 1.9, or 2 h. In some examples the cooking time is greater than about 2 h. In some examples, the cooking time is less than about 1 h.

The cooking step 28 may occur with agitation, or without agitation. In the example in which the cooking step 28 occurs with agitation, the cooking agitation may be in the range of about 10 rpm to about 15 rpm. In some example, the cooking agitation is about 10, 10.5, 11, 11.5, 12, 12.5, 13, 13.5, 14, 14.5, 15 rpm.

It will be appreciated that the firmness of the curd 30 will vary depending on, inter alia, the fat content, protein content, and moisture. For example, a decrease in total solids or protein content will results in a less firm curd as does an increase in moisture or fat content.

The cooking step 28 is selected to obtain the desired firmness.

Following the cooking step 28, a separation step 32 separates the firm cut curd 30 obtained in the cooking step 28, from the whey 18. Separation may be carried out by liquid removal, for example, by placing the curd 30 and whey 18 a cloth bag, a mold, a whey drainer, or the like, by centrifugation separation with a centrifuge, by use of membrane technology or evaporation.

Following the separation step 32, the curd 30 is subjected to a curd cooling and/or washing step 34. In the curd washing step 34, the curds are washed with a wash water at a wash temperature.

In some examples the wash water is chlorinated. In some examples the wash water is acidified. In some example, the wash water is acidified with phosphoric acid. In one example, the wash water is acidified and chlorinated. In a specific example, the wash water is acidified with phosphoric acid and chlorinated. Such conditions are well known to a person skilled in the art. In some examples, the wash temperature is selected such that following the curd wash step 34 the washed curds 36 are at a temperature of about 3° C. to about 10° C. In one example, the washed curds 36 are at a temperature of about 5° C. to about 9° C. In one example, the washed curds are at a temperature of about 6° C. to about 8° C. In one example, the washed curds are at a temperature of about 3° C., 3.5° C., 4° C., 4.5° C., 5° C., 5.5° C., 6° C., 6.5° C., 7° C., 7.5° C., 8° C., 8.5° C., 9° C., 9° C., or 10° C. In some examples, the curd washing 34 step is carried out in a vertical washing tower or a horizontal washing tank.

Following curd cooling and washing 34, the washed curds 36 are subjected to a curd draining step 38 to obtain drained curd 40. In the curd draining step 38 the wash water is removed from the washed curds 36.

In one example, the curd draining step 38 is carried out in a suitable device, for example, a decanter type device. In one example, the washed curd 36 is dried using a fluidized bed or ring drying to obtain drained curd 40 with a desired moisture content. In one example, the desired moisture content of the washed curd is about 74% to 85%. This process further removes excess of moisture from the curd hence increasing the total solids of curd.

In a specific example, the curd draining step 38 is carried out by pumping the washed curds thorough a curd drainer. In one example, a belt speed is from 4 rpm to 6.5 rpm, a belt pressure of from 30 psi to 50 psi, and a pump speed of from 50 rpm to 100 rpm are used to pump the washed curds 36 through the curd drainer.

Dressing the Curd

As noted above, in conventional manufacturing process for cottage cheese, for example, cheese curds are suspended in, or blended with, a dressing.

As described herein, the method of preparing a smooth cheese product comprises a dressing step. In the dressing step, the curd obtained in the method of producing a cheese curd of a specific firmness (described above, and shown in FIG. 1), is combined with a dressing and subjected to a processing step. For example the process step comprises a shearing or a milling step(s) to obtain a smooth cheese product. In a specific example, the smooth cheese product is a smooth cottage cheese, that has a smooth texture similar to Greek yogurt.

It has been surprisingly determined that specific properties of the curd, the dressing, and processing parameters when combining the curd and dressing, result in a cheese product of desired texture and viscosity. In a specific example, the smooth cheese product comprises about 1% (wt/wt) to about 4% (wt/wt) milk fat, about 8% (wt/wt) to about 14% (wt/wt) protein.

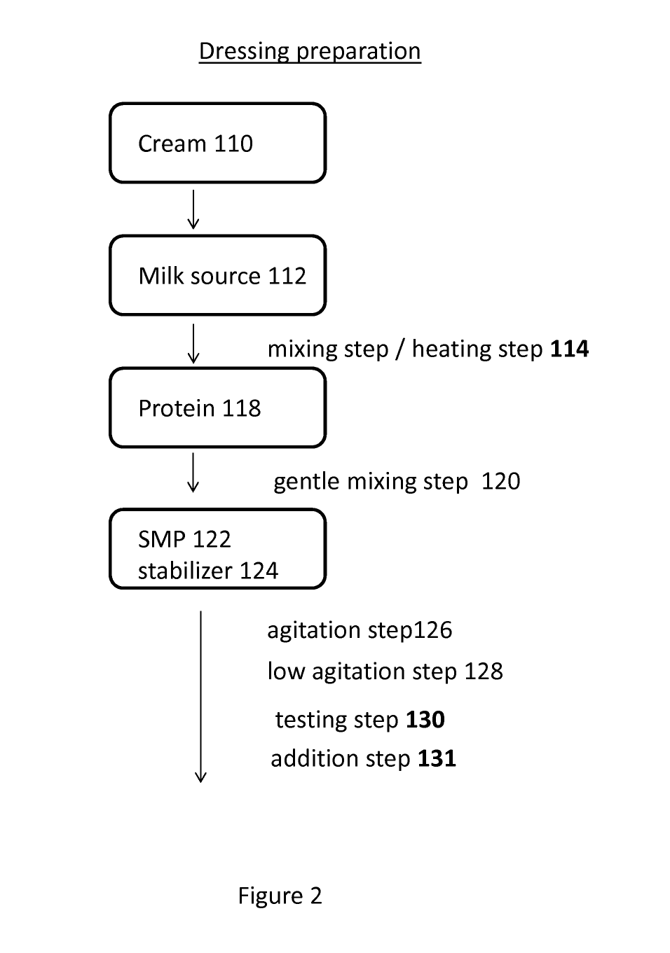

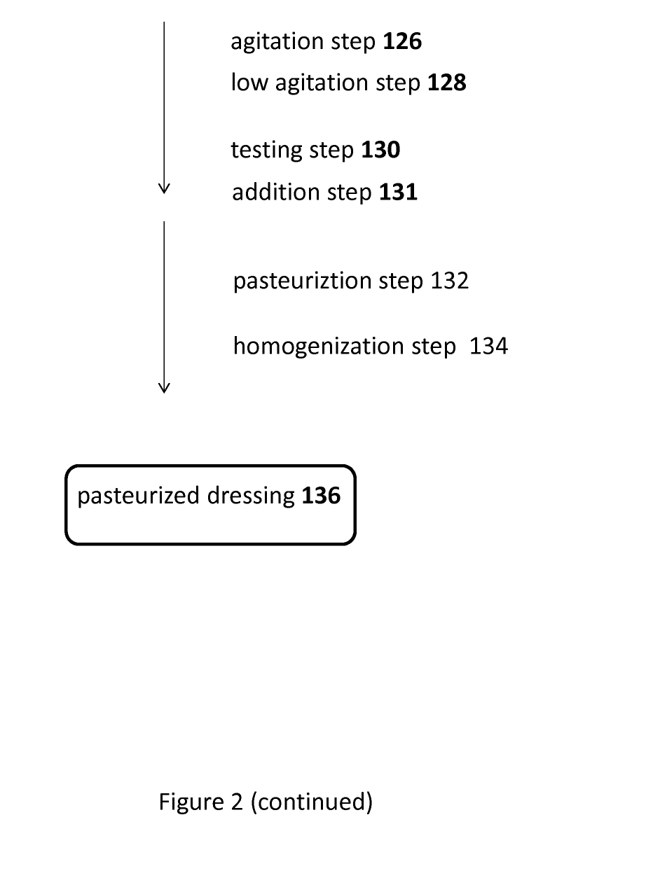

One example of dressing the curd of a specific firmness (described above and in FIG. 1) is shown in FIG. 2. As shown in FIG. 2 dressing the curd may be carried out in a vat, where a dressing is added to the curd. Once the dressing is added, the mixture is stirred, for example by mechanical agitation.

Alternatively, dressing may be carried out in conjunction with cooling of the curd. Once the curd is cooled it may be transferred to a creaming tank or to a surge tank. The creaming tanks may be vertical or horizontal, and will depend upon the type of mixing agitator. Such systems may also include load cells which permit accurate measurement of the amount of dressing added to the curd, thereby permitting accurate ratios of curd and dressing entering the creamer.

The amount protein, fat, and total solids (TS), in the dressing may be adjusted according to the smooth cheese product requirement. For example, in a rich cheese product, fat can be much higher. In some examples, the dressing comprises about 5% to about 15% protein, about 1% to about 20% fat, and about 15% to about 30% solids.

Further, the dressing may be fermented or non-fermented.

In one embodiment, the dressing comprises cream, whole milk, skim milk powder, milk protein concentrate, and a stabilizer.

Cream (for example 40% (wt/wt)) may be used. In some examples, the cream is used in the amount of about 3% (wt/wt), 3.5% (wt/wt), 4% (wt/wt), 4.5% (wt/wt), or 5% (wt/wt).

Skim milk powder is used in the range of about 2% (wt/wt) to about 8% (wt/wt). In some examples, the skim milk powder is used in the amount of about 5% (wt/wt), 5.5% (wt/wt), 6% (wt/wt), 6.5% (wt/wt), 7% (wt/wt), 7.5% (wt/wt), or 8% (wt/wt).

Milk protein concentrates (MPC) isolates (MPI), micellar caseins (MCC) or whey protein in various forms, from isolates, concentrates or microparticulated, in the range of 20-90% (wt/wt) milk protein. In some examples, the MPC is about 20%, 25%, 30%, 35%, 40%, 45%, 50%, 55%, 60%, 65%, 70%, 75%, 80%, 85%, or 95% (wt/wt). In a another example, whey protein microparticulated the protein is about 20%, 25%, 30%, 35%, 40%, 45%, 50%, 55%, 60%, 65%, 70%, 75%, 80%, 85%, or 95% (wt/wt).

In some examples, protein added to the dressing is obtained from a non-animal protein source or suspension. For example, from a non dairy concentrated beverage including, but not limited to, soy, pea, almond, and rice milk. In some examples, the non dairy protein source or suspension is used in combination with the mammal derived milk. For example, vegetable milk may be used at a low concentration of milk. In some examples the non dairy portion is between about 0% (v/v) and about 70% (v/v) of the total protein in the dressing. In some examples, the dressing is mainly composed of fruit juice with dairy proteins added in a portion between 0-20%. In some examples, whey protein isolates are added to the fruit juice, at a concentration of about 2%, 3%, 4%, 5%, 6%, 6.5%, 7%, 7.5%, 8%, 8.5%, 9%, 9.5%, 10% (wt/wt).

Stabilizer may include one or more of gums, starches, emulsifiers, and phosphates. Non-limiting examples of stabilizer include one or more of locust bean gum, guar gum, carrageenan, gellan, starch, xanthan, pectin, starch, mono- and diglycerides, lecithin, and sodium and potassium phosphates.

Generally, the stabilizer is less than about 3% (wt/wt) of the dressing. In some examples, the stabilizer is present form about 0.1% (wt/wt) to about 1% (wt/wt). In some examples, the stabilizer is present form about 0.2% to about 0.8%. In some example, the stabilizer is present at about 0.2%, 0.25%, 0.3%, 0.35%, 0.4%, 0.45%, 0.5%, 0.55%, 0.6%, 0.65%, 0.7%, 0.75%, 0.8% (wt/wt).

In addition to stabilizers, soluble fiber may be added to the dressing, at a concentration necessary to be nutritionally relevant, with levels that may range between about 5% and 30%. Non limiting examples of soluble fiber include one or more of inulin, citrus fiber, beta-glucans, polysaccharides from bacteria, yeast or fungi.

The level of milk fat in the dressing may range between about 5% and 30%. The level of protein in the dressing may range from about 5% (wt/wt) to 20% (wt/wt). The level of total solidsin the dressing may range from about 18% (wt/wt) to 40% (wt/wt).

In a specific example, the method of dressing the curd is as follows. Referring to FIG. 2, cream 110 and milk 112 are combined, and subject to a mixing step and heating step 114, for about 5 to 20 minutes and heating the mixture to about 40° C., for a heating time of about 15 min to 1 h. During the heating step 116, additional protein 118, in the form of liquid concentrates, or evaporated milk or powders, is added, and the mixture subjected to a gentle mixing step 120. Stabilizer 124 is added slowly to the mixture, and subjected to an agitation step 126, in some examples agitated on high. In a specific example, as shown in FIG. 2, skim milk powder (SMK) 118, is also added with stabilizer 124. Once the powders are added, the mixture is subjected to a low agitation step 128, in which the temperature is maintained at about 40° C. to about 50° C.

Optionally, the amount of fat, protein and solids may be tested, in testing step 130, and adjusted if necessary. In one example, the dressing comprises, or is adjusted to comprise, about 3% to about 5% fat, about 8% to about 12% protein, about 20% to about 30% TS. This is generally shown as optional testing step 130

Optionally, an additive is added to the dressing. For example, coco and/or a sugar may be added to the dressing. This is generally shown as option addition step 131.

In some example, the additive comprises probiotics and/or addition of compounds beneficial to health and well being such as phytosterols and polyphenols, or bioactive peptides.

The dressing is then subject to a pasteurization step 132 and/or homogenization step 134 to obtain a pasteurized dressing 136.

In a specific example, the pasteurization step 132 and/or homogenization step 134 is effected using an HTST (High Temperature Short Time) pasteurizer, for example, a two-stage homogenizer at about 1000 psi to about 3000 psi. In this process, in one example, the dressing is maintained in holding tubes at about 80° C. to about 95° C. for a holding time of about 16 seconds to about 45 seconds. It will be appreciated that alternate temperatures and holding times may be selected, depending on the composition of the dressing and the extent of heat treatment necessary for flavor and texture development.

The pasteurized dressing is discharged from the HTST pasteurizer into a discharge dressing take and maintained at about 20° C. to about 30° C. and agitation. In a specific example, the agitation speed is about 30% or about 12 rpm.

The pasteurized dressing 136 may be fermented, or may be combined with the curd 40 and further proceed to the smooth cheese product 400.

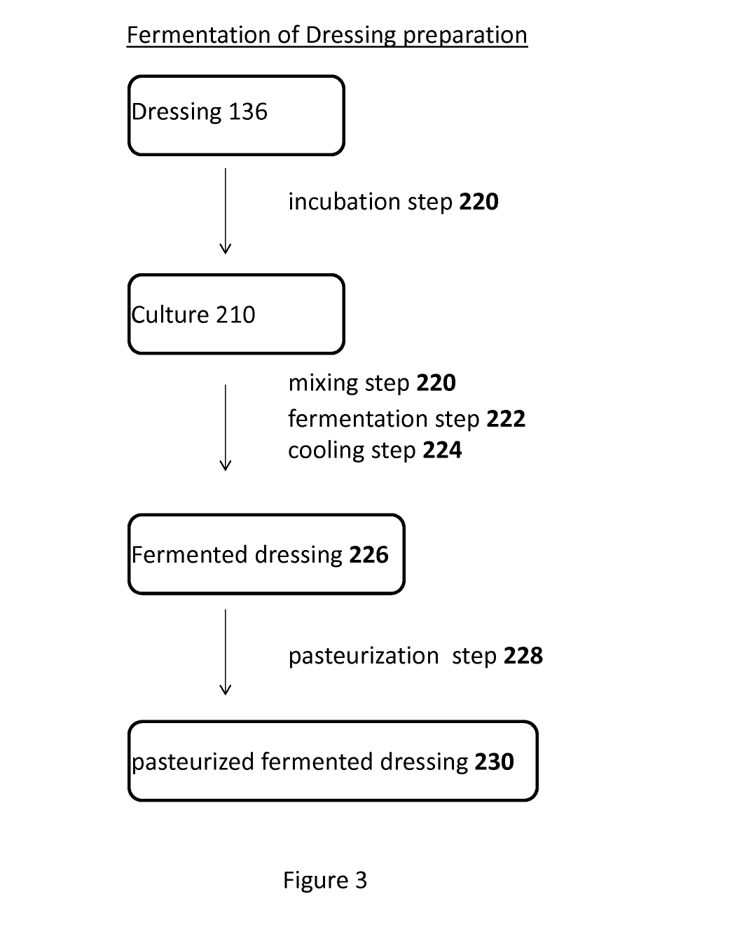

The example in which pasteurized dressing 136 is fermented with a culture 210 is shown in FIG. 3. In a specific example, the culture 210 is a bacterial culture.

In some examples, the pasteurized dressing 136 is fermented culture 210, wherein culture 210 is a probiotic bacteria. In a specific example, the dressing is fermented with Bifidobacterium infantis.

In another example, Biobest® culture is used.

In some examples, the dressing is fermented with the addition of protective cultures such as HOLDBAC® YM-C Plus, HOLDBAC® YM-B Plus, and/or HOLDBAC® YM-XPK.

Is some examples, the dressing is fermented with buttermilk cultures.

If the dressing is fermented, the following steps are followed. Dressing 136 is subjected to an incubation step 220, selected for an optimized temperature for culture 210 growth. In one example, the incubation step 220 comprises a temperature in the range of about 22° C. to about 26° C., or about 23° C. to about 25° C.

Culture 210 is then added to dressing 136 and the mixture is subjected to a mixing step 222, for example, agitation for about 20 minutes to about 40 minutes to allow the culture(s) to mix.

Following mixing step 220, the mixture is subjected to a fermentation step 222. The fermentation step 222 proceeds for a fermentation time. The fermentation time is selected to achieve a titratable acidity (TA) of about 1.3%-1.7%, and a pH of about 4.4-4.75. The fermentation time will depend on the kinetics of acidification and the type of culture. In some examples, the mixture is incubated for about 16-30 hours.

Following the fermentation step 222, the mixture is subjected to a cooling step 224 and the fermented mixture cooled to a temperature about 15° C., or less. This results in a fermented dressing 226.

Fermented dressing 226 is then processed to a smooth cheese product. Alternatively, fermented dressing 226 is subjected to fermented dressing pasteurization step 228, to stabilize the dressing, to produce a fermented pasteurized dressing 230.

Producing a Smooth Cheese Product

In producing a smooth cheese product, it is important that both the dressing or fermented dressing are not subjected to excess shear. Over shear will cause whey separation from the product, which is undesirable.

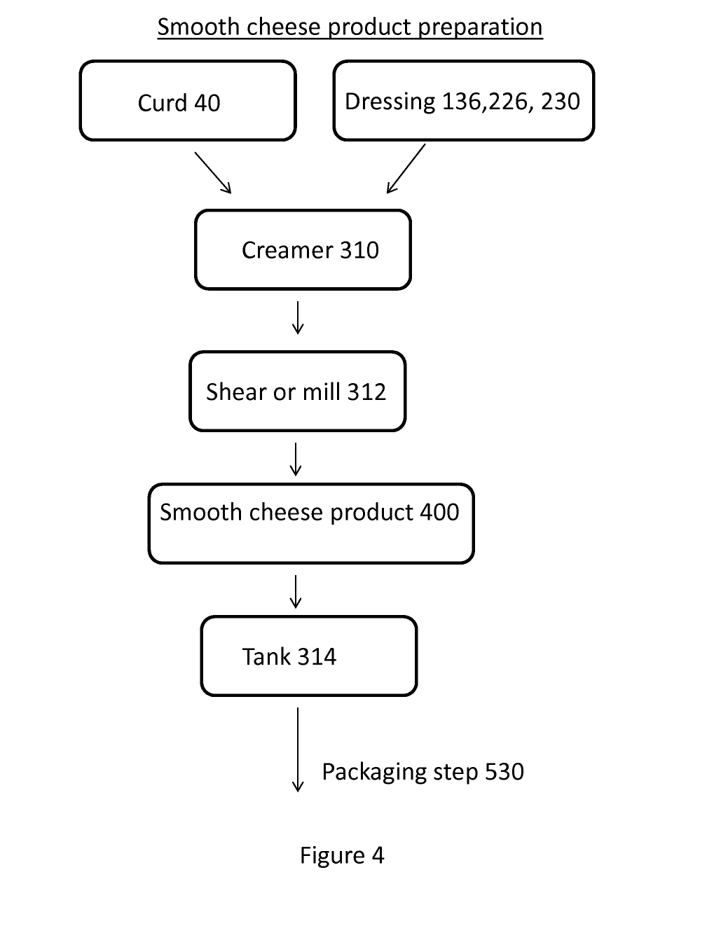

One example of producing a smooth cheese product is shown in FIG. 4. In this example, the curd 40 and the dressing 136, fermented dressing 226, or pasteurized fermented dressing 230, are combined in a creamer 310, in a curd:dressing ratio of about 50:50 to 70:30. The curd:dressing mixture is pumped in to creamer 310 and agitated until the curd and dressing are substantially uniformly mixed. In the case of a mixture having a mass of about 5000 kg, the mixture is agitated for about 45 minutes. If the mass is less than about 5000 g, the mixture is agitation is longer to ensure a proper mixing.

The curd and dressing mixture is subjected to a smoothing step using a shear or milling device 312. The smoothing steps results in a smoothed cheese product 400. While not wishing to be bound by theory, it is thought that during the smoothing step, micro or sub-micro particles are formed which have a smooth texture.

The smooth cheese product 400 in one example resembles 40% mascarpone, or Greek yogurt.

For example, this smooth product 400 can be pumped at temperatures of about 4° C. to about 20° C. The viscosity of the smoothed product is in the range of about 5000 cP to about 80000 cPs, and shows a shear thinning behaviour.

The viscosity of smooth cheese product 400 can be measured using a viscometer or rheometer, or using other means known in the art.

The smoothing step is carried out with a shear or milling device 312, for example a shear pump or shear mill or high shearing device, with similar size reduction function.

During size reduction, in one example, following the shearing or mill, the particle size of the curd 40 is less than about 1000 μm.

In some examples, the particles size of the curd 40 is less than about 1000 μm. In some examples, the particle size of the curd 40 is less than about 1000 μm, less than about 900 μm, less than about 800 μm, less than about 700 μm, less than about 600 μm, less than about 500 μm, less than about 400 μm, less than about 300 μm, less than about 200 μm, less than about 100 μm. It will be appreciated that there may be a distribution of particle sizes.

In some example, following the shearing or milling, the smooth cheese product has smooth appearance and mouthfeel in the range of a Greek yogurt (for example 2% MF plain Greek Yogurt (about 10% protein) or 40% Mascarpone (about 40% fat, 6% protein)

In one example, a high shearing device is a STEPHAN MICROCUT® device in which the mixture of curd and dressing are pressed by the rotating cutter head against the metal carbide cutters on the cutting ring. The operating parameters will vary depending on the degree of smoothness and viscosity, as well as the ratio between curd and dressing.

In another example, a Boston Shear Mill or Quadra Z emulsifier is used, or similar shear pump or shear mill which has rotor-stator arrangement. Variable speed drives may also be used to further adjust the shear and mixing effect. In one example, the mixture of curds and dressing passes through a few sets of rotor/stator heads which rotate at a high speed to shear the cottage cheese into a smooth product. In some examples, the rotor/stator rotates from about 1000 rpm to about 6000 rpm. In specific examples, the rotor/stator rotates at about 1000 rpm, 1500 rpm, 2000 rpm, 2500 rpm, 3000 rpm, 3500 rpm, 4000 rpm, 4500 rpm, 5000 rpm, 5500 rpm, or 6000 rpm. The processed smooth product is discharged from an outlet and into a storage tank.

In a specific example, the following parameters were used with a Quadro Ytron Z Emulsifier to obtain a smooth product.

Smoothing conditions that cause irreversible, visible phase separation need to be avoided. It will be appreciated that these conditions will depend on the formulation (concentration of protein and polysaccharide, as well as type of polysaccharide used) and ratio of dressing to curd.

It will be appreciated that the foregoing process may be a batch process, a semi-continuous process, or a continuous process. In some examples, the process is a semi-continuous process. In some example, the process is a continuous process.

Following smoothing, the smooth cheese product may be discharged in to tank 314, before packing of smooth cheese product 400.

The resultant smooth cheese product 400 may then be subjected to a packaging step 530, and packaged. Means packaging are known in the art.

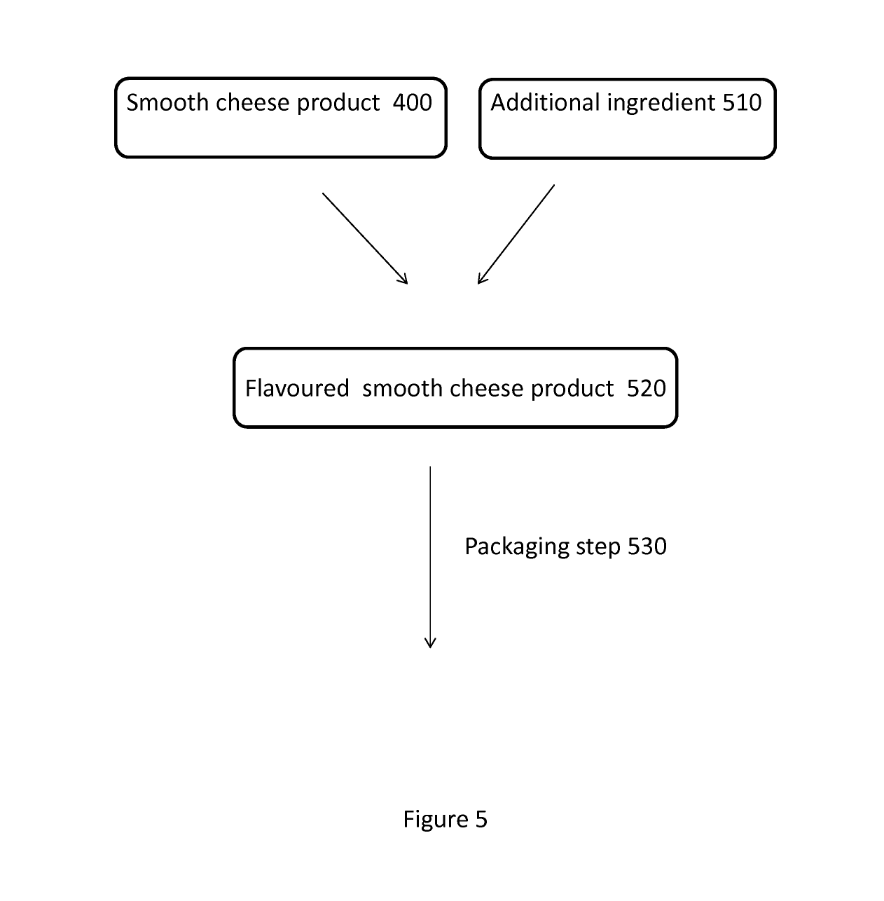

Alternatively, as shown in FIG. 5, one or more additional ingredients 510 may be added to the smooth cheese product 400 to product a flavoured smooth cheese product 520, before packaging step 530.

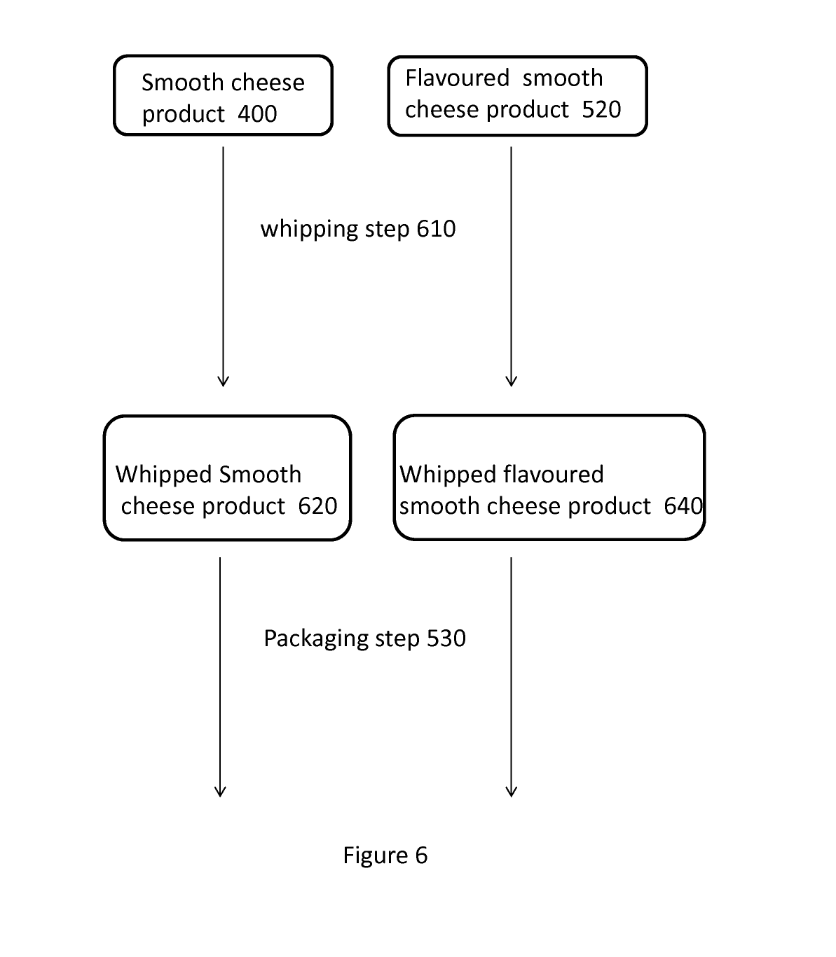

Alternatively, as shown in FIG. 6, the smooth cheese product 400 or flavoured smooth cheese product 520 are subjected to a whipping step 610, to produce a whipped smooth cheese product 620 or whipped flavoured smooth cheese product 640, respectively, prior to packaging step 530.

Following packaging, the smoothed cheese product 400, 520, 620, or 640, are refrigerated until use.

It will be appreciated that during the packing process, for example, when the smooth cheese product is pumping into the containers, the viscosity may drop during pumping, due to the shear thinning properties of the smooth cheese product. However, by ensuring the above-noted conditions of flowability, viscosity, and curd particle size, following the smoothing process, the packed product will remain at the desired viscosity or it will recover its viscosity during final cooling and storage.

Additional Ingredient(s)

In one example, an additional ingredient 510 is a salt, a sweetener, acetic acid, vinegar, food grade acids, aromas, spices, flavors (including but not limited to vanilla, hazelnut, irish creme, mocha, almond, liqueurs, chocolate, coco, berry, fruit etc.), seasonings, cocoa, mustard, coloring agents, tomato, sweet pepper, vitamins, antioxidants (such as ethoxyquin, vitamin E, vitamin C, BHA, BHT, TBHQ, ascorbyl palmitate), preservatives (such as sorbates, benzoates etc.), flavour preparation, and the like food colorants and/or dyes, aromas, flavours.

A sweetener refers to any substance that when added to a food or beverage sweetens the taste of the smooth product. A sweetener may be natural or artificial. Non-limiting examples include, but are not limited to, to as sugar, corn syrup, maltodextrins, dextrose, saccharine, acesulfame, sucralose, lactose, stevia alcaloids, aspartame, sugar alcohols, etc.

An additional ingredient may also include a texture enhancer. In some examples, the texture enhancer is water, food grade acid, lactose, fats, gums, starches, carbohydrates, sources of monovalent and divalent cations

In some examples, the additional ingredient is a nutritional supplement. Examples of nutritional supplement include, but are not limited to limited to vitamins, minerals, carbohydrates, prebiotics, probiotics, and biologically active agents.

An additional ingredient may be a fruit (including diced fruit), vegetables (including diced vegetables), and/or the like.

An additional ingredient may be a dairy protein or non-dairy protein. Examples of non-dairy protein includes, but is not limited to, soya protein, wheat protein or other suitable non-milk derived protein source.

Food colourant or food dye refers to a substance that when added to the smooth product changes the color of the smooth product. Exemplary food colorings include, but are not limited to, caramel coloring, annatto, chlorophyll, betanin, turmeric, paprika, saffron, pandan and butterfly pea.

Following the addition of one or more additional ingredient, the resultant smooth product may be packaged using a packaging step 530. Means packaging are known in the art.

Methods of the invention are conveniently practiced by providing the compounds and/or compositions used in such method in the form of a kit. Such a kit preferably contains the composition. Such a kit preferably contains instructions for the use thereof.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method of producing a smooth cheese product, comprising,
preparing a cheese curd from a milk source, said cheese curd having a firmness of between about 80 pounds of force (lbs of force) to about 250 lbs force;
mixing the cheese curd with a dressing to form a mixture; and
subjecting the mixture to a smoothing step to produce the smooth cheese product,
wherein the smooth cheese product is flowable at temperatures of about 4° C. to about 20° C., and has a viscosity is in the range of about 5000 to about 80000 cP following the smoothing step.

2. The method of claim 1, wherein the step of preparing a cheese curd comprises,
coagulating a milk source with a coagulant to form a coagulated curd and whey;
cutting the coagulated curd in the whey;
healing the cut coagulated curd;
heating the healed cut coagulate curd and whey; and
separating the cut coagulated curd from the whey.

3. The method of claim 1, wherein said smoothing step comprises, applying a shearing force or milling force to the mixture.

4. The method of claim 3, wherein said shearing force or milling force is produced with a device to generate a particle size of the curd less than about 1000 μm.

5. The method of claim 4, wherein said device comprises one or more rotor/stator heads, which rotate between about 1000 rpm to about 6000 rpm.

6. The method of claim 5, wherein said device is a Boston Shear Mill, or a Quadra Z emulsifier.

7. The method of claim 4, wherein said device is a STEPHAN MICROCUT®.

8. The method of anyone of claim 1, wherein said milk source comprises milk from a mammal.

9. The method of claim 8, wherein said mammal is a cow, buffalo, goat, sheep, horse, donkey, water buffalo, yak, reindeer, or camel.

10. The method of claim 2, wherein said coagulant comprises an enzyme.

11. The method of claim 10, wherein said enzyme comprises rennet, rennin, chymosin, CHY-MAX® M, CHY-MAX® EXTRA, CHY-MAR®, HANNILASE®, THERMOLASE®, NATUREN®, or FAR-M®.

12. The method of claim 2, wherein said coagulant comprises an acidifier.

13. The method of claim 12, wherein said acidifier comprises CO₂, organic acids, inorganic acids, lactic acid, citric acid, hydrochloric acid, phosphoric acid, oxalic acid, tartaric acid, fumaric acid, succinic acid, malic acid, gluconic acid, adipic acid, and phytic acid, or glucono-delta-lactone.

14. The method of claim 2, wherein said coagulant comprises a lactic acid producing bacterium.

15. The method of claim 14, wherein said lactic acid producing bacterium comprises a bacterium from the order Lactobacillales or Actinomycetales.

16. The method of claim 14, wherein said lactic acid producing bacterium comprises, Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp.

17. The method of claim 14, wherein said lactic acid producing bacterium comprises, Streptococcus lactis, Streptococcus cremoris, Lactococcus lactis, and/or Lactococcus cremoris.

18. The method of claim 14, wherein said lactic acid producing bacterium comprises, Streptococcus thermophiles

19. The method claim 2, wherein said cutting is manual or automated.

20. The method of claim 2, wherein said healing comprises incubating said cut coagulated curd for a healing time, wherein said healing time is about 20 to about 40 min.

21. The method of claim 2, wherein said heating step comprises heating said cut curd coagulum and whey at a cooking temperature and a cooking time to achieve the firmness of the cut curd coagulum of about 80 pounds of force (lbs of force) to about 250 lbs force.

22. The method of claim 2, wherein said separating step comprises liquid removal with a curd drainer.

23. The method of claim 1, further comprising addition of at least one additional ingredient.

24. The method of claim 23, wherein said at least one additional ingredient is a sweetener, a flavour, an aroma, a colour, a spice, a fruit, a fruit, a flavor preparation, or a salt.

25. A smooth cheese product made according to a method of claim 1, wherein said smooth cheese product is flowable at a temperature of about 4° C. to about 20° C., has a viscosity of about 5000 cP to about 80000 cP and has a particle size of the curd of from about 10μ to 1000 μm

26. The smooth cheese product of claim 25, comprising about 10% to about 20% protein, about 1-10% fat, and about 15-30% solids.

27. A smooth cheese product comprising about 10% to about 20% protein, about 1 to 10% fat, and about 15-30% solids, wherein said smooth cheese product is flowable at a temperature of about 4° C. to about 20° C., has a viscosity of about 5000 cP to about 80000 cP, and has a particle size of curd of from about 10 μm to 1000 μm.

28. The smooth cheese product of claim 25, further comprising an additional ingredient.

29. The smooth cheese product of claim 28, wherein said additional ingredient is one or more of a salt, a sweetener, acetic acid, vinegar, food grade acid, aromas, spice, flavor seasoning, cocoa, mustard, coloring agent, tomato, sweet pepper, vitamin, antioxidant, preservative, flavour preparation, food colorants and/or dyes.

30. The smooth cheese product of claim 29, wherein said flavor is vanilla, hazelnut, Irish creme, mocha, coco, almond, liqueurs, chocolate, berry, or fruit.

31. The smooth cheese product of claim 29, wherein said antioxidant is ethoxyquin, vitamin E, vitamin C, BHA, BHT, TBHQ, or ascorbyl palmitate.

32. The smooth cheese product of claim 29, wherein said preservative is a sorbates, or a benzoates.
